(19) United States
(12) Patent Application Publication
(10) Pub. No.: US 2018/0088395 A1
(43) Pub. Date: Mar. 29, 2018

(54) DISPLAY MODULE, ELECTRONIC DEVICE AND MANUFACTURING METHOD THEREOF

(71) Applicant: Chiun Mai Communication Systems, Inc., New Taipei (TW)

(72) Inventors: CHEN-SHENG HSU, New Taipei (TW); MENG-JER HUANG, New Taipei (TW)

(21) Appl. No.: 15/715,175

(22) Filed: Sep. 26, 2017

(30) Foreign Application Priority Data
Sep. 27, 2016 (CN) 201610853457.6

(51) Int. Cl. G02F 1/1333; G02F 1/1335

(52) U.S. Cl. CPC G02F 1/133308; G02F 1/133512; H04M 1/0266; G02F 2001/133322; G02F 2001/133331

(57) ABSTRACT

A display module for an electronic device includes a frame, a backlight module, a display panel, and a cover. The frame includes a bottom wall, and a side wall surrounding a peripheral edge of the bottom wall and defining a receiving slot with the bottom wall. The backlight module and the display panel are received in the receiving slot. The backlight module is positioned between the display panel and the bottom wall. The cover covers the receiving slot. A light-leakage prevention layer is formed on an inner surface of the side wall facing the receiving slot. The light-leakage prevention layer is made of material having both light absorbing effect and anti-etching effect.

### FIELD

The disclosure generally relates to display modules, and particularly to a display module with a light-leakage prevention effect, and an electronic device and a manufacturing method of the display module.

### BACKGROUND

With developments of liquid crystal display (LCD), increasing a screen proportion and narrowing a frame of the LCD have become a common goal of various manufacturers. However, as the frame of the LCD is narrowed, light emitted from a backlight module may easily leak from a junction of a viewing region and the frame (usually coated by an ink layer) of the LCD, and forms a light-leaking phenomenon at an edge of the LCD.

### BRIEF DESCRIPTION OF THE DRAWINGS

Many aspects of the present disclosure can be better understood with reference to the drawings. The components in the drawings are not necessarily drawn to scale, the emphasis instead being placed upon clearly illustrating the principles of the disclosure. Moreover, in the drawings, like reference numerals designate corresponding parts throughout the views.

FIG. 1 is an isometric view of an electronic device, according to an exemplary embodiment.

FIG. 2 is a partial, cross-sectional view of a display module of the electronic device of FIG. 1.

FIG. 3 is an isometric view of a frame of display module of FIG. 2.

FIG. 4 is a flowchart of a method for manufacturing the electronic device of FIG. 1, according to a first exemplary embodiment.

FIG. 5 is a flowchart of a method for manufacturing the electronic device of FIG. 1, according to a second exemplary embodiment.

### DETAILED DESCRIPTION

It will be appreciated that for simplicity and clarity of illustration, where appropriate, reference numerals have been repeated among the different figures to indicate corresponding or analogous elements. In addition, numerous specific details are set fourth in order to provide a thorough understanding of the embodiments described herein. However, it will be understood by those of ordinary skill in the art that the embodiment described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “ substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising,” when utilized, means “including, but not necessarily limited to”; it specifically indicates open-ended inclusion or membership in the so-described combination, group, series, and the like.

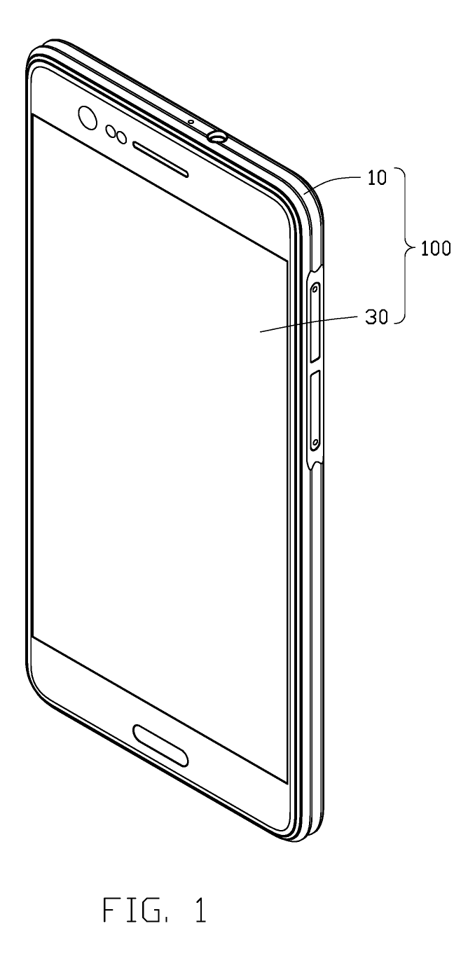

FIG. 1 is an isometric view of an electronic device 100, according to an exemplary embodiment. The electronic device 100 can be, but is not limited to, a mobile phone, a personal digital assistant (PDA), or a tablet personal computer. In this exemplary embodiment, the electronic device 100 is a mobile phone. The electronic device 100 includes a base body 10 and a display module 30 assembled to the base body 10.

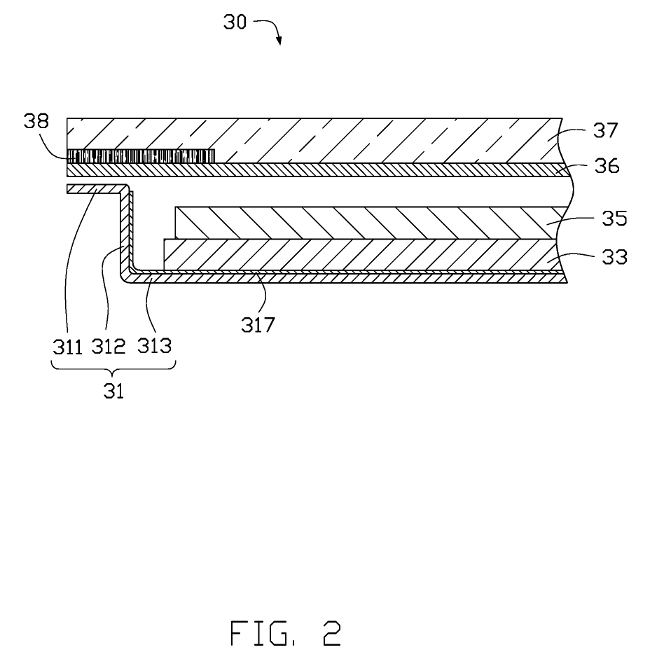

FIG. 2 is a partial, cross-sectional view of a display module 30 of the electronic device of FIG. 1. The display module 30 includes a frame 31, a backlight module 33, a display panel 35, and a cover 37.

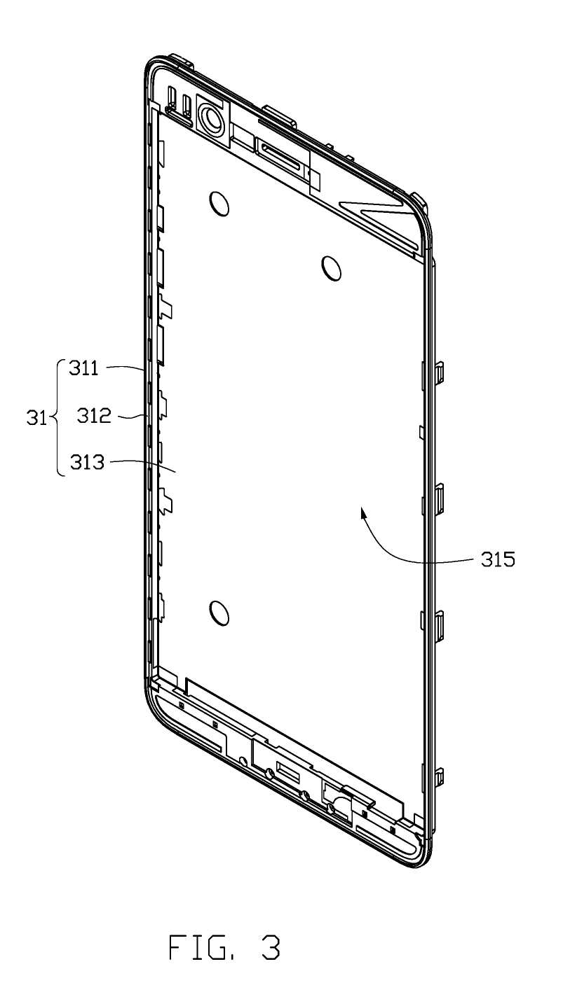

In this exemplary embodiment, the frame 31 can be a middle frame of the electronic device 100, and made of metallic material. Referring to FIG. 3, the frame 31 includes a top wall 311, a side wall 312, and a bottom wall 313. The side wall 312 surrounds a peripheral edge of the bottom wall 311 and these two together define a receiving slot 315 with the bottom wall 311. The top wall 311 surrounds a peripheral edge of the side wall 312. The bottom wall 313 is connected to an end of the side wall 312 at an inner side of the side wall 312. The top wall 311 is connected to another end of the side wall 312 at an outer side of side wall 312. The top wall 311 is parallel to the bottom wall 313. The backlight module 33 and the display module 35 are received in a receiving slot 315.

The backlight module 33 is positioned between the display panel 35 and the bottom wall 313. The cover 37 is positioned on the top wall 311 and covers the receiving slot 315. A light-leakage prevention layer 317 is formed on an inner surface of the side wall 312 facing the receiving slot 315. The light-leakage prevent layer 317 is made of material having both light absorbing effect and anti-etching effect. In this exemplary embodiment, the light-leakage prevention layer 317 is an electro-deposition layer. The cover 37 is made of transparent material having a protecting effect, such as glass or plastic. In this exemplary embodiment, the light-leakage prevention layer 317 has a dark color such as black or grey to obtain the light absorbing effect.

In other embodiment, the light-leakage prevention layer 317 can be also formed on an inner surface of the bottom wall 313 facing the receiving slot 315. The light-leakage prevention layer 317 can absorb light emitted from the backlight module 33. Thus, the display module 30 can obtain a better light-leakage preventing effect.

In other embodiment, the display module 30 further includes a touch sensing layer 36. The touch sensing layer 36 is positioned between the display panel 35 and the cover 37. The touch sensing layer 36 is also positioned between the top wall 311 and the cover 37. The touch sensing layer 36 is configured to sense touching operations of a user on the display module 30.

In other embodiment, the display module 30 further includes an optical glue layer (not shown) replacing the touch sensing layer 36. The optical glue layer is positioned between the display panel 35 and the cover 37 to adhere the display panel 35 and the cover 37 together. The optical glue layer is also positioned between the top wall 311 and the cover 37.

In other embodiment, the display module 30 further includes a gap (not shown) replacing the touch sensing layer 36. The gap is positioned between the display panel 35 and the cover 37. The gap is also positioned between the top wall 311 and the cover 37.

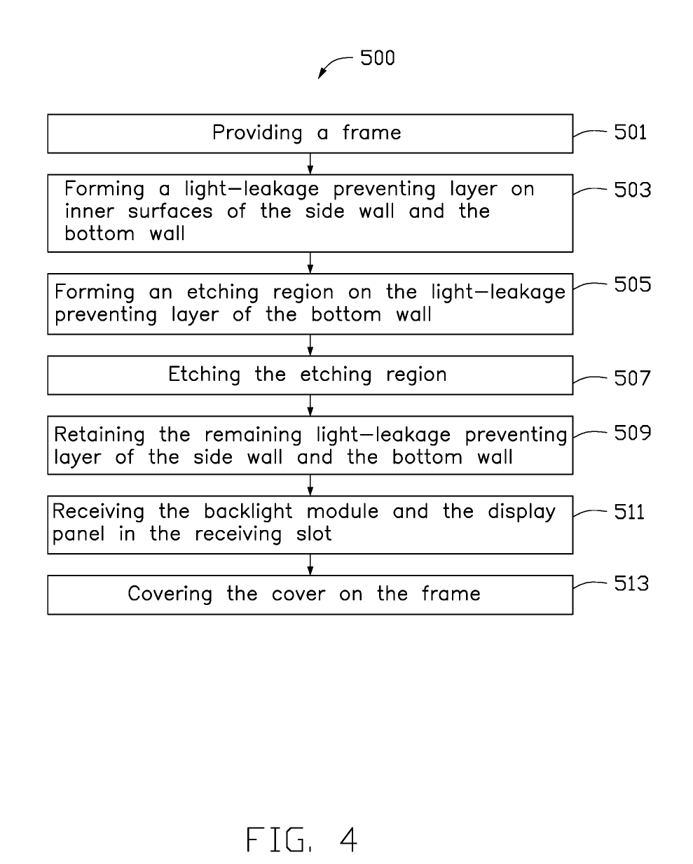

Referring to FIG. 4, a flowchart is presented in accordance with a first example embodiment which is being thus illustrated. The example method 500 is provided by way of example, as there are a variety of ways to carry out the method. Each block shown in FIG. 4 represents one or more processes, methods or subroutines, carried out in the exemplary method 300. Additionally, the illustrated order of blocks is by example only and the order of the blocks can change according to the present disclosure. The exemplary method 500 can begin at block 501.

At block 501, a frame 31 is provided. The frame 31 includes a top wall 311, a side wall 312, and a bottom wall 313. The side wall 312 and the bottom wall 313 define a receiving slot 315 together.

At block 503, a light-leakage prevention layer 317 is formed on inner surfaces of the side wall 312 and the bottom wall 313, wherein the inner surface is defined as the surface facing the receiving slot 315. In this exemplary embodiment, the light-leakage prevention layer 317 is an electro-deposition layer formed by coating electrophoresis on the inner surfaces of the side wall 312 and the bottom wall 313 facing the receiving slot 315. The electrophoresis coating can be formed by anode electrophoresis or cathode electrophoresis. The electrophoresis coating material can include charged organic resin (8%-10%), paint (1%-2%), and film-forming additives. The light-leakage prevention layer 317 has an anti-etching effect and would not effected by an etching process at block 507. Thus, the bottom wall 313 below the light-leakage prevention layer 317 can be protected from being etching.

At block 505, an etching region is formed on the light-leakage prevention layer 317 of the bottom wall 313. In this exemplary embodiment, a portion of the light-leakage prevention layer 317 can be removed by laser engraving to expose a portion of the bottom wall 313 to serve as the etching region.

At block 507, the etching region is etched. Thus, the thickness of the exposed portion of bottom wall 313 corresponding to the etching region is thinned, so that the receiving slot 315 can have a relative larger space to receive other elements of the electronic device 100.

At block 509, the remaining light-leakage prevention layer 317 of the side wall 312 and the bottom wall 313 is retained, and the side wall 312 and the bottom wall 313 with the remaining light-leakage prevention layer 317 serve as a light-leakage preventing region.

At block 511, the backlight module 33 and the display panel 35 are received in the receiving slot 315.

At block 513, the cover 37 is positioned on the frame 31 to form the display module 30.

In other embodiment, the cover 37 and a touch sensing layer 36 are positioned on the frame 31 to form the said display module 30.

In other embodiment, the cover 37 and optical glue layer are positioned on the frame 31 to form the said display module 30.

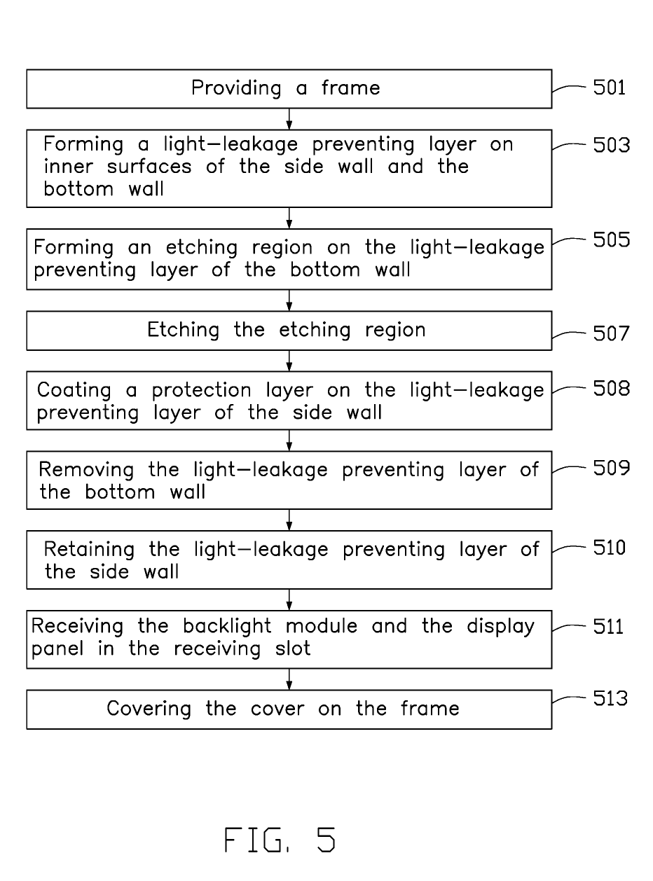

Referring to FIG. 5, in a second exemplary embodiment, only the side wall 312 with the remaining light-leakage prevention layer 317 serves as a light-leakage preventing region, the method 500 further includes following blocks.

At block 508, a protection layer is coated on the light-leakage prevention layer 317 on the inner surface of the side wall 312. In this exemplary embodiment, an anti-pickling layer is coated on the light-leakage prevention layer 317 on the inner surface of the side wall 312 to serve as the protection layer.

At block 509, the light-leakage prevention layer 317 on the bottom wall 313 is removed. For example, the light-leakage prevention layer 317 on the bottom wall 313 is removed by pickling.

Accordingly, at block 510, only the light-leakage prevention layer 317 on the side wall 312 is retained. The bottom wall 311 is exposed to serve as a grounding region of the electronic device 100. Other steps in the manufacturing method 500 of the electronic device 100 in this exemplary embodiment are substantially the same as other steps shown in FIG. 4. Therefore, details are omitted.

The light-leakage prevention layer 317 of the display module 30 can absorb the light emitted by the backlight module 33, and avoid the light emitted by the backlight module 33 leaking from a frame of the display module 30 so that the display module 30 can have the light-leakage preventing effect. In addition, the light-leakage prevention layer 317 is formed by the anti-etching layer of the frame 31 during an etching process. Thus, an extra process to form the light-leakage prevention layer 317 is not needed. Comparing with a traditional way of manually pasting shading material on the sidewall 312 to form the light-leaking prevention layer 317, the light-leaking prevention layer 317 of the present disclosure is formed in a simpler way and has a lower cost.

It is to be understood, however, that even through numerous characteristics and advantages of the present disclosure have been set fourth in the foregoing description, together with details of assembly and function, the disclosure is illustrative only, and changes may be made in details, especially in the matters of shape, size, and arrangement of parts within the principles of the disclosure to the full extent indicated by the broad general meaning of the terms in which the appended claims are expressed.

What is claimed is:

1. A display module for an electronic device, the display module comprising:
a frame, the frame comprising:
a bottom wall; and
a side wall surrounding a peripheral edge of the bottom wall and defining a receiving slot with the bottom wall;
a backlight module, received in the receiving slot;
a display panel, received in the receiving slot, and the backlight module being positioned between the display panel and the bottom wall; and
a cover covering the receiving slot, the frame further comprising a light-leakage prevention layer formed on an inner surface of the side wall facing the receiving slot, the light-leakage prevention layer being made of material having both light absorbing effect and anti-etching effect.

2. The display module of claim 1, wherein the light-leakage prevention layer is further formed on an inner surface of the bottom wall facing the receiving slot.

3. The display module of claim 1, wherein the light-leakage prevention layer is an electro-deposition layer.

4. The display module of claim 1, wherein the bottom wall serves as a grounding region of the electronic device.

5. An electronic device comprising:
a base body;
a display module assembled to the base body, the display module comprising:
a frame, the frame comprising:
a bottom wall; and
a side wall surrounding a peripheral edge of the bottom wall and defining a receiving slot with the bottom wall,
a backlight module, received in the receiving slot;
a display panel, received in the receiving slot, and the backlight module being positioned between the display panel and the bottom wall; and
a cover covering the receiving slot, the frame further comprising a light-leakage prevention layer formed on an inner surface of the side wall facing the receiving slot, the light-leakage prevention layer being made of material having both light absorbing effect and anti-etching effect.

6. The electronic device of claim 5, wherein the light-leakage prevention layer is further formed on an inner surface of the bottom wall facing the receiving slot.

7. The electronic device of claim 5, wherein the light-leakage prevention layer is an electro-deposition layer.

8. The electronic device of claim 5, wherein the bottom wall serves as a grounding region of the electronic device.

9. The electronic device of claim 5, wherein the frame is a middle frame of the electronic device.

10. A method for making a display module for an electronic device, comprising:
providing a frame comprising a side wall and a bottom wall, the side wall surrounding a peripheral edge of the bottom wall, the side wall and the bottom wall together defining a receiving slot;
forming a light-leakage prevention layer on inner surfaces of the side wall and the bottom wall, wherein the inner surfaces face the receiving slot, and wherein the light-leakage prevention layer is made of material having both light absorbing effect and anti-etching effect;
forming an etching region on the light-leakage prevention layer of the bottom wall;
etching the etching region;
retaining the light-leakage prevention layer of the side wall to serve as a light-leakage preventing region;
receiving a backlight module and a display panel in the receiving slot, the backlight module being positioned between the display panel and the bottom wall; and
covering the cover on the receiving slot to form the display module.

11. The method of claim 10, further comprising:
protecting the light-leakage prevention layer of the side wall by coating a protection layer on the light-leakage prevention layer of the side wall; and
removing the light-leakage prevention layer of the bottom wall and retaining the light-leakage prevention layer of the side wall.

12. The method of claim 10, wherein the light-leakage prevention layer is an electro-deposition layer.

13. The method of claim 10, further comprising:
also retaining the light-leakage prevention layer of the bottom wall as the light-leakage preventing region.
